(19) United States
(12) Patent Application Publication
(10) Pub. No.: US 2025/0307409 A1
(43) Pub. Date: Oct. 2, 2025

(54) SYSTEM AND METHOD FOR PERFORMING TEST FOR TAMPERING VERIFICATION IN ACTIVATION OF SOFTWARE TO BE EXECUTED BY STORAGE CONTROLLER

(71) Applicant: Hitachi Vantara, Ltd., Yokohama-shi (JP)

(72) Inventor: Yuya MIYOSHI, Tokyo (JP)

(73) Assignee: Hitachi Vantara, Ltd., Yokohama-shi (JP)

(21) Appl. No.: 18/830,843

(22) Filed: Sep. 11, 2024

(30) Foreign Application Priority Data
Mar. 29, 2024 (JP) 2024-057671

(51) Int. Cl. G06F 21/57; H04L 9/32

(52) U.S. Cl. CPC G06F 21/572; H04L 9/3247

(57) ABSTRACT

A system acquires verification software to be executed by a storage controller. The verification software includes a program for detecting tampering in the verification software. The system tampers with a part of the verification software according to an instruction from a user. The system installs the verification software tampered with at the part in the storage controller and activates the verification software. The system presents, to the user, the result of verification of tampering by the verification software which has been received from the storage controller.

### REFERENCE TO RELATED APPLICATIONS

The present application claims priority from Japanese patent application JP 2024-057671 filed on Mar. 29, 2024, the content of which is hereby incorporated by reference into this application.

### BACKGROUND OF THE INVENTION

### 1. Field of the Invention

The present invention relates to tests of functions of verifying software to be executed by storage systems.

### 2. Description of the Related Art

Data storage is a basic function of a computer system. In many computer systems, when a large amount of data is handled, the data is stored in a storage device. A storage system stores data in a built-in storage medium (storage drive) such as a hard disk drive (HDD) or a solid state drive (SSD), and performs data writing and reading processes according to commands from the outside.

Software in the storage system may be tampered with in the supply chain from shipment from the factory to provision to customers. There is a function of verifying that updated software has not been tampered with in updating the software, at the time of activation and the like of the software, after the updating of the software, wherein this function is called secure boot. The secure boot function verifies software to be activated, using a digital signature and the like, at the time of activation of the storage system.

As a background art of the present application, there is JP 2023-88706 A. JP 2023-88706 A discloses “An electronic control device 10 including a ROM having a rewritable area and an un-rewritable area for storing a control program, a control unit 60, and a test execution unit 90. The control unit executes the control program using acquired input data and calculates a control value. The un-rewritable area stores test data and an assumed result of test corresponding to the input data. When the control program has been rewritten, the test execution unit executes the control program using the test data, compares the result of test as the result of calculation using the test data with the assumed result of test, and determines whether or not the rewritten control program is normal. The test execution unit permits activation of the rewritten control program determined to be normal and restricts activation of the rewritten control program determined to be abnormal.”.

### CITATION LIST

### Patent Literature

Patent Literature 1: JP 2023-88706 A
Patent Literature 2: US 2022/0413981 A

### SUMMARY OF THE INVENTION

The secure boot (authenticity verification) can ensure authenticity and integrity of software in the storage system. However, the user (including the system administrator) can not know whether the authenticity verification functions correctly at the time of activation of the system. This has been causing a possibility of degradation of the reliability of the storage system for the user.

In one aspect of the present disclosure, there is provided a system for performing test for tampering verification in activation of software to be executed by a storage controller, the system includes a management system and a storage controller, wherein the management system stores verification software to be executed by the storage controller, the verification software includes a program for detecting tampering in the verification software, the management system is adapted to tamper with a part of the verification software according to an instruction from a user, and install the verification software tampered with at the part in the storage controller, the storage controller is adapted to activate the verification software, and the management system is adapted to present, to the user, a result of verification of tampering by the verification software which has been received from the storage controller.

In one aspect of the present disclosure, it is possible to improve the reliability of the storage system.

### BRIEF DESCRIPTION OF THE DRAWINGS

FIG. 1 illustrates an example of the hardware structure of a storage system and devices relating thereto;

FIG. 2 illustrates an example of the structure of software stored in a management controller;

FIG. 3 illustrates an example of the structure of software stored in a disk controller;

FIG. 4 is a block diagram for illustrating an outline of processes executed by programs in the management controller and the disk controller, in activating the storage controller;

FIG. 5 illustrates an example of the structure of a management device;

FIG. 6 illustrates an advance preparation for testing a secure boot function;

FIG. 7 illustrates an example of an authentication screen for an administrator, for the purpose of tampering of verification software;

FIG. 8 illustrates an example of a verification-software selection screen;

FIG. 9 illustrates an example of a tampering input screen and a tampering result screen for the verification software;

FIG. 10 illustrates an example of the tampering input screen and the tampering result screen for the verification software;

FIG. 11 is a view illustrating a method for installing tampered verification software in the storage controller;

FIG. 12 illustrates a flowchart of an activation process by the storage controller;

FIG. 13 illustrates an example of a tampering detection message; and

FIG. 14 illustrates an example of a verification-status screen.

### DESCRIPTION OF THE INVENTION

Hereinafter, an embodiment will be described with reference to the drawings. For convenience, when necessary, the description will be divided into a plurality of sections or embodiments. However, unless otherwise specified, they are not unrelated to each other, and there are relationships therebetween, for example, such that one of them is modifications, details, supplementary explanations, and the like of a part or the entirety of the others. Furthermore, in the following, when there is a description about the number and the like (including the number, a numerical value, an amount, a range, and the like) of elements, the number of elements is not limited to the specified number and may be equal to or greater than or less than the specified number, unless otherwise stated or unless clearly limited to the specified number.

A processor or arithmetic device executes programs stored in a main storage device to realize predetermined functions. The main storage device stores the programs to be executed by the arithmetic device, and data necessary for executing the programs. The programs include an operating system (OS) (not illustrated), and programs. The arithmetic device can include a plurality of chips and a plurality of packages.

The programs are executed by the arithmetic device, thereby performing predetermined processes using a storage device and a communication port (communication device). Therefore, in the present embodiment, descriptions using the programs as the subject may be descriptions using the arithmetic device as the subject. Also, the processes executed by the programs are processes performed by the calculating machine and the calculating system in which the programs operate.

The arithmetic device operates according to the programs, thereby operating as functional units (means) for realizing predetermined functions. Furthermore, the arithmetic device also operates as functional units (means) for realizing respective plural processes executed by the respective programs. The calculating machine and the calculating system are a device and a system including these functional units (means).

In one embodiment of the present specification, there is provided a tool for enabling a user to tamper with a part of software to be executed by a storage system. This enables the user to test a secure boot function of the software. By enabling the user to confirm that the secure boot function of the software normally functions, it is possible to improve the reliability of the storage system for the user.

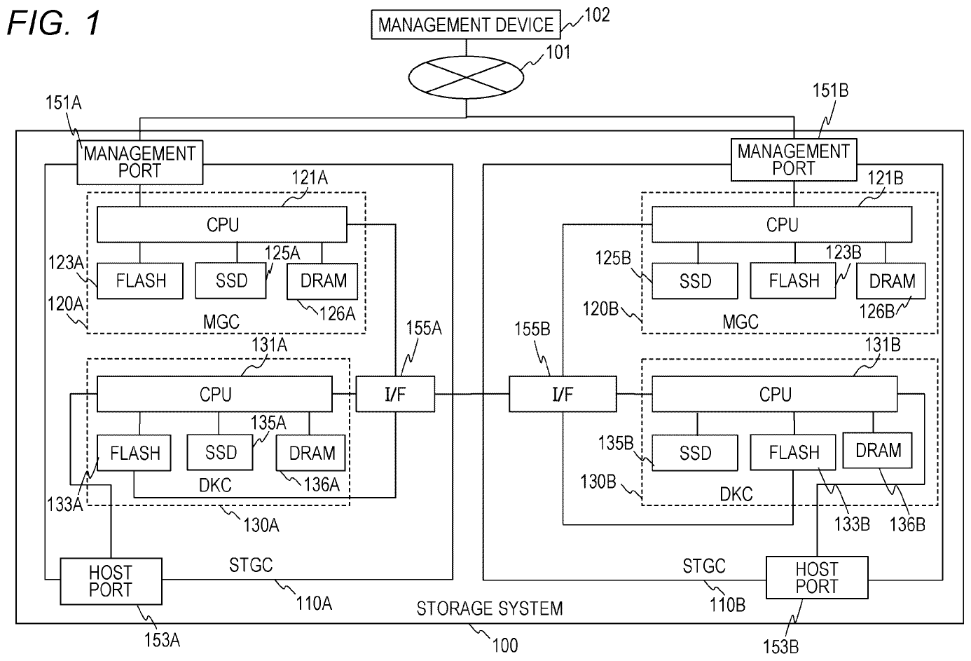

With reference to FIG. 1, there will be described an example of the hardware structure of a storage system 100 and devices relating thereto according to an embodiment of the present specification. One or more hosts (not illustrated) are connected to the storage system 100 through a network (not illustrated). Each host issues various requests such as a reading request or a writing request (I/O request) to the storage system 100 through the network, in order to manage host data. As the network, it is possible to use a protocol such as Fibre Channel (FC) or the Ethernet, for example.

A management device 102 is connected to the storage system 100 through a network 101. An administrator of the system manages the storage system 100 by manipulating the management device 102. As the network 101, it is possible to use a local area network (LAN), for example. If a tampering of software is detected in the storage system 100, information thereabout is transmitted to the management device 102. The management device 102 presents the information to the administrator, through a display device (not illustrated in FIG. 1).

The storage system 100 incorporates two storage controllers (STGCs) 110A and 110B having the same function for high reliability of the system. The storage system 100 may include one or more storage drives (not illustrated), as storage media for holding data (referred to as host data) from the hosts. The storage drives may be constituted by, for example, hard disk drives (HDD) or solid state drives (SSD).

Hereinafter, there will be described an example of the two storage controllers 110A and 110B in the storage system 100, but the number of storage controllers is not particularly limited. The storage system may include only one or three or more storage controllers, and the storage controllers may be mounted on a plurality of nodes for performing communication through a network.

The storage controller 110A includes a management controller (MGC) 120A, and a disk controller (DKC) 130A. These are respective different hardware devices. The disk controller is also referred to as an input/output controller. The storage controller 110A further includes a management port 151A, a host port 153A, and an internal communication interface 155A.

The management port 151A is an interface for enabling the storage controller 110A to communicate with the management device 102, and the host port 153A is an interface for enabling the storage controller 110A to transmit and receive host data to and from the host. The internal communication interface 155A is an interface for enabling the storage controller 110A to communicate with the other storage controller 110B. The internal communication interface 155A stores environment information, environment settings, and the like in the system, and enables communication between devices.

The management controller 120A manages the storage system 100 according to instructions from the administrator. For example, the management controller 120A executes settings of the storage system 100, which include creation and setting of a volume.

The management controller 120A includes a central processing unit (CPU) 121A as an arithmetic device for executing management processes, a flash memory 123A, and an SSD 125A. The number of each is not limited. The management controller 120A further includes a DRAM 126A used as a main storage device. The DRAM is a memory including a volatile storage medium.

The CPU 121A executes programs stored in the DRAM 126A to realize predetermined management functions. Processes executed by the CPU 121A are processes executed by the management controller 120A. The CPU 121A communicates with the management device 102 through the management port 151A.

The CPU 121A verifies and activates software which is stored in itself and is to be executed by itself. Further, the CPU 121A verifies and activates a part of software stored in the disk controller 130A. In the verification, the CPU 121A determines whether or not the software has been tampered with. For verification of authenticity of the software, it is possible to use a known technique using a digital signature, for example.

For example, a digital signature is generated from a private key and a hash value of software (binary image) for executing a process in the storage system. A media image including the digital signature and the software is installed in the storage system 100. The CPU 121A generates a verification digital signature from a public key and a hash value of the installed software. By comparing the digital signature stored in advance with the verification digital signature, it is possible to verify the authenticity of the software (binary image).

By verification of the authenticity of the software, it is possible to improve the reliability of the storage system 100. Incidentally, verification to be executed by the disk controller 130A may be executed by the management controller 120, and at least a part of the verification of the software by the disk controller 130A is executed by the management controller 120A.

The flash memory 123A and the SSD 125A are storage devices with different interface protocols. For example, the flash memory 123A can use Serial Peripheral Interface (SPI), while the SSD 125 can use Non-Volatile Memory Express (NVMe). Incidentally, all the software may be stored in a storage device of one type.

In activating the management controller 120A, the CPU 121A first accesses the flash memory 123A and activates software (programs) stored therein. Thereafter, the CPU 121A accesses the SSD 125A and activates software in the SSD 125A. The CPU 121A verifies the software in the SSD 125A to determine whether or not there is a tampering. The CPU 121A also verifies software in the disk controller 130A. This improves the reliability of the security of the storage system 100.

The disk controller 130A processes inputting and outputting of host data. The disk controller 130A stores host data received from the host in the storage drive, in response to a writing request from the host. Also, the disk controller 130A reads designated data from the storage drive, and transfers the data to the host, in response to a reading request from the host. Logically, host data is stored in a volume. The volume is associated with a storage area in the storage drive.

The disk controller 130A includes a CPU 131A as an arithmetic device for executing processes for inputting/outputting host data, a flash memory 133A, and an SSD 135A. These are respective different hardware devices. The disk controller 130A further includes a DRAM 136A used as a main storage device.

The CPU 131A executes programs stored in the main storage device to realize predetermined management functions. Processes executed by the CPU 131A are processes executed by the disk controller 130A. The CPU 131A communicates with the host through the host port 153A.

The CPU 131A verifies and activates software which is stored in itself and is to be executed by itself. In the verification, the CPU 131A determines whether or not the software has been tampered with. The method for the verification is as described above. This can improve the reliability of the storage system 100.

The flash memory 133A and the SSD 135A are storage devices with different interface protocols. For example, the flash memory 133A can use SPI, while the SSD 135A can use NVMe. Incidentally, all the software may be stored in a storage device of one type.

The disk controller 130A is activated in response to a notification from the management controller 120A. Before the activation of the disk controller 130A, the management controller 120A verifies a part of the software in the disk controller 130A. If no tampering is detected, activation of the disk controller 130A is started.

In one embodiment of the present specification, the management controller 120A verifies software stored in the flash memory 133A. The management controller 120A can access the flash memory 133A through the internal communication interface 155A without interposing the CPU 131A.

After the verification by the management controller 120A, the disk controller 130A accesses the flash memory 133A, activates the verified software, and further verifies the remaining part of the software to determine whether or not there is a tampering. In one embodiment of the present specification, the remaining part is software stored in the SSD 135A.

In one embodiment of the present specification, the storage controller 110B has the same structure as that of the storage controller 110A and includes the same types of constituent elements. Specifically, the storage controller 110B includes a management controller 120B, and a disk controller 130B. The storage controller 110B further includes a management port 151B, a host port 153B, and an internal communication interface 155B. The storage controllers 110A and 110B communicate with each other through the internal communication interfaces 155A and 155B.

Similarly to the management controller 120A, the management controller 120B includes a CPU 121B, a flash memory 123B, and an SSD 125B. The management controller 120B further includes a DRAM 126B used as a main memory device. Similarly to the disk controller 130A, the disk controller 130B includes a CPU 131B, a flash memory 133B, and an SSD 135B. The disk controller 130B further includes a DRAM 136B used as a main storage device.

The management controller 120B and the disk controller 130B execute the same operations as the aforementioned operations of the management controller 120A and the disk controller 130A, respectively. The management controllers 120A and 120B may have respective different structures, and the disk controllers 130A and 130B may have respective different structures.

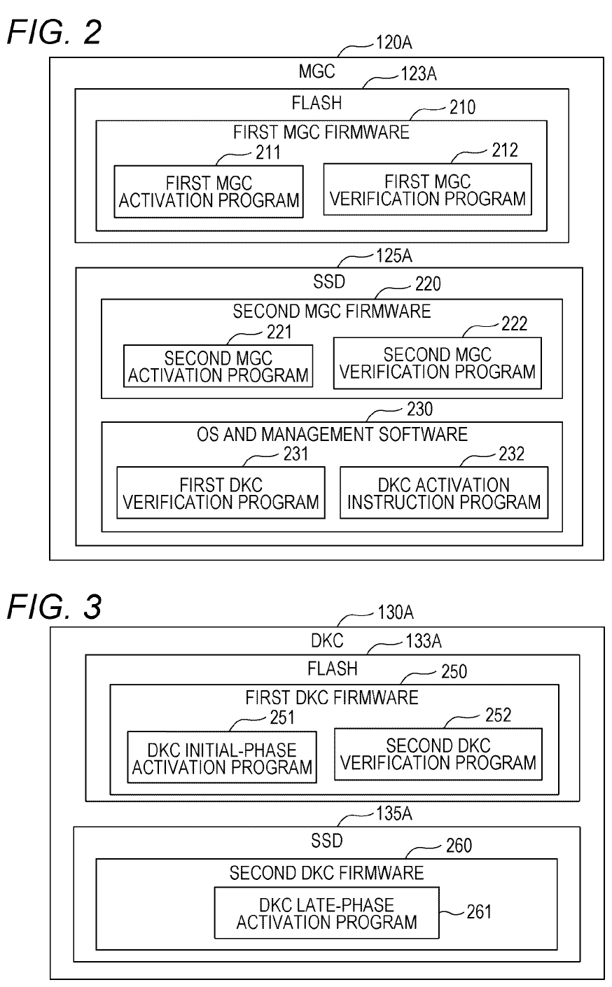

FIG. 2 illustrates an example of the structure of the software (programs) stored in the management controller 120A. The management controller 120B in the storage controller 110B stores software similar to that in the management controller 120A. The flash memory 123A in the management controller 120 A stores first MGC firmware 210. The first MGC firmware 210 includes an MGC activation program 211 and a first MGC verification program 212.

The SSD 125A in the management controller 120A stores second MGC firmware 220, and an operating system (OS) and management software 230. The management software operates on the OS. The second MGC firmware 220 includes a second MGC activation program 221 and a second MGC verification program 222. The OS and management software 230 include a first DKC verification program 231, and a DKC activation instruction program 232.

FIG. 3 illustrates an example of the structure of the software (programs) stored in the disk controller 130A. The disk controller 130B in the storage controller 110B stores software similar to that in the disk controller 130A.

The flash memory 133A in the disk controller 130A stores first DKC firmware 250. The first DKC firmware 250 includes a DKC initial-phase activation program 251, and a second DKC verification program 252. The SSD 135A in the disk controller 130A stores second DKC firmware 260. The second DKC firmware 260 includes a DKC late-phase activation program 261.

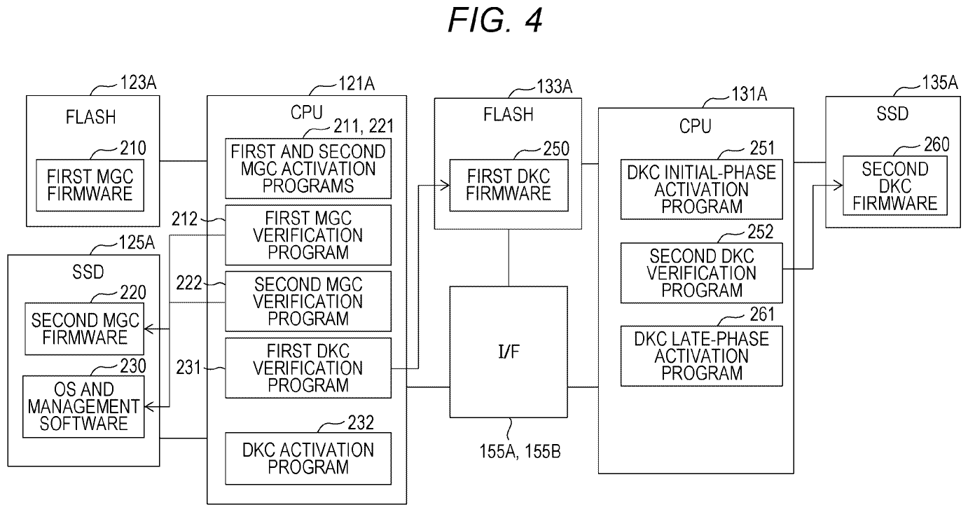

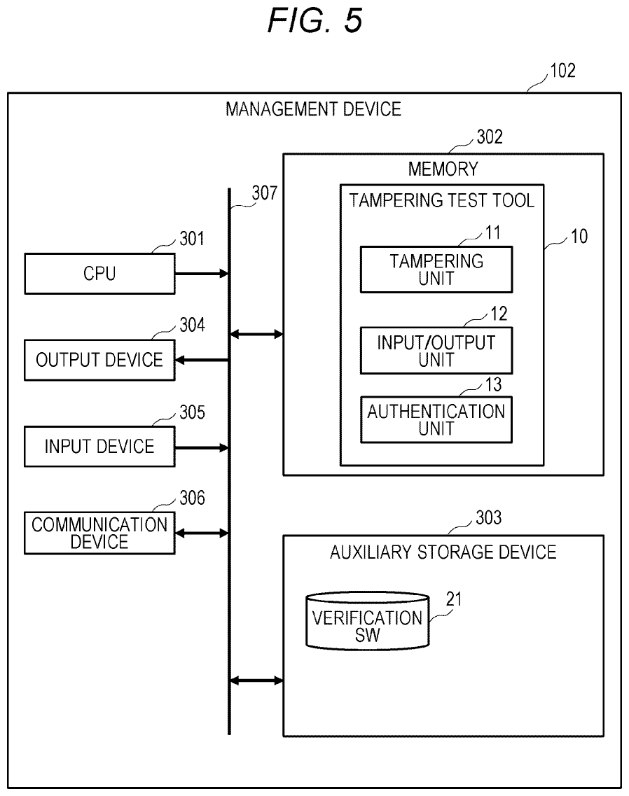

FIG. 4 is a block diagram for illustrating an outline of processes executed by the programs in the management controller 120A and the disk controller 130A, in activating the storage controller 110A. The management controller 120B and the disk controller 130B also execute similar processes.

If activation of the storage controller 110A is started, the CPU 121A in the management controller 120A activates the first MGC activation program 211 in the first MGC firmware 210 stored in the flash memory 123A. The first MGC activation program 211 activates other programs in the first MGC firmware 210, which include the first MGC verification program 212.

The first MGC verification program 212 verifies the second MGC firmware 220 stored in the SSD 125A. When the verification of the second MGC firmware 220 has been completed, thereby resulting in the determination that there is no tampering, the first MGC activation program 211 activates the second MGC activation program 221 in the second MGC firmware 220 stored in the SSD 125A. The second MGC activation program 221 activates other programs in the second MGC firmware 220, which include the second MGC verification program 222.

The second MGC verification program 222 verifies the OS and management software 230 stored in the SSD 125A. When the verification the OS and management software 230 has been completed, thereby resulting in the determination that there is no tampering, the second MGC activation program 221 activates the programs in the OS and management software 230.

The OS and management software 230 include a first DKC verification program 231, and a DKC activation instruction program 232. The first DKC verification program 231 accesses the flash memory 133A in the disk controller 130A through the internal communication interfaces 155A and 155B, and verifies the first DKC firmware 250.

When the verification of the first DKC firmware 250 has been completed, thereby resulting in the determination that the first DKC firmware 250 is normal, the DKC activation instruction program 232 instructs the CPU 131A in the disk controller 130A to perform activation. The CPU 131A executes the DKC initial-phase activation program 251 included in the first DKC firmware 250 in the flash memory 133A.

The DKC initial-phase activation program 251 activates the second DKC verification program 252 included in the DKC firmware 250 having been verified. The second DKC verification program 252 accesses the SSD 135A in the disk controller 130A and verifies the second DKC firmware 260 stored therein. The DKC initial-phase activation program 251 executes activation of other programs in the first DKC firmware 250, in parallel with the verification of the second DKC firmware 260.

When the verification of the second DKC firmware 260 has been completed, thereby resulting in the determination that the second DKC firmware 260 is normal, the DKC late-phase activation program 261 in the second DKC firmware 260 is executed. The DKC late-phase activation program 261 activates other programs in the DKC firmware 260. The DKC firmware 260 is main firmware that defines inputting and outputting of host data by the disk controller 130A.

FIG. 5 illustrates an example of the structure of the management device 102. The management device 102 can have a structure of a calculating machine, for example. The management device 102 includes a central processing unit (CPU) 301 for executing various programs, a memory (main storage device) 302 for storing various programs, and an auxiliary storage device 303 for storing various data. The CPU 301 can include one or more cores, and the memory 302 is constituted by, for example, a DRAM including a volatile storage area. The auxiliary storage device 303 is constituted by, for example, a hard disk drive (HDD), a flash memory, or the like, and can provide a non-volatile storage area.

The management device 102 further includes an output device 304 for presenting information to the user of the device, an input device 305 for inputting user's instructions, images, and the like, and a communication device 306 for communicating with other devices. These are connected to each other through a bus 307.

The output device 304 is constituted by a device such as a display, a printer, or a speaker. The input device 305 is constituted by a device such as a keyboard, a mouse, or a microphone. The output device 304 presents results of inputs from the user, and also presents results of processes by the management device 102. The input device 305 inputs user's instructions to the management device 102.

The communication device 306 receives data transmitted from other devices connected thereto through a network, which include a user terminal, for example. Further, the communication device 306 transmits results of processes by the management device 102 to the other devices. The CPU 301 executes programs stored in the memory 302 to realize predetermined functions, and these programs are loaded to the memory 302 from the auxiliary storage device 303, for example. Incidentally, the structure of the management device 102 is not particularly limited, and some of the devices may be omitted, and at least some of the functions may be implemented by a logic circuit.

The auxiliary storage device 303 stores verification software 21. The verification software 21 is software for testing secure boot, and basically performs only the secure boot. In the verification software 21, some of functions of normal software to be installed in the storage system 100 are omitted. This can prevent the storage system 100 from performing an erroneous operation for the host data, in tampering tests. In the verification software 21, for example, functions of changing of the volume structure, setting of hosts, host IO processing, and the like are omitted.

The memory 302 stores software to be executed by the CPU 301, including an OS and application programs. FIG. 5 illustrates a tampering test tool 10 for software in the storage system 100, as an example. The tampering test tool 10 includes a plurality of programs for testing the secure boot in the storage system 100. Specifically, the tampering test tool 10 includes a plurality of programs including a tampering unit 11, an input/output unit 12, and an authentication unit 13.

The tampering unit 11 tampers with the verification software 21, in accordance with an instruction from the administrator. The input/output unit 12 receives inputs of information for testing the secure boot function of the storage system 100 and provides the administrator with a GUI for presenting the results of the tests. The authentication unit 13 executes authentication of login by the administrator.

In one embodiment of the present specification, users including the administrator of the storage system 100 can execute tests of the secure boot implemented in the storage system 100. This can improve the reliability of the storage system 100 for users.

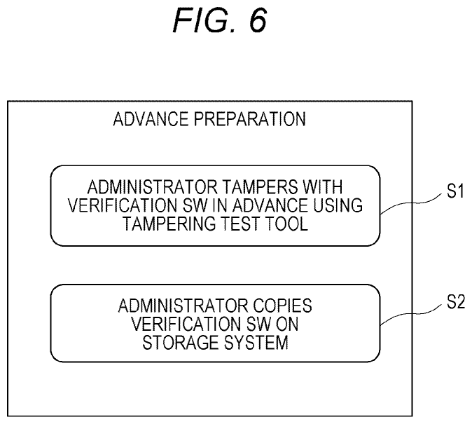

FIG. 6 illustrates an advance preparation for testing the secure boot function. As illustrated in FIG. 6, the administrator tampers with the verification software 21 using the tampering test tool 10 in the management device 102 (S1), and copies (installs) the tampered verification software on the storage system 100 (S2).

The administrator can manually tamper with the verification software 21 stored in the management device 102, using the input device 305 and the output device 304. Incidentally, the administrator may also use the tampering test tool 10 by accessing the management device 102 through the user terminal.

The management device 102, and the combination of the management device 102 and the user terminal are each a management system. Processes executed by the management device 102 may be distributed to a plurality of devices and may be processed thereby. In this manner, the management system for executing tests of the secure boot function for software together with the storage controllers includes one or more arithmetic devices and one or more storage devices.

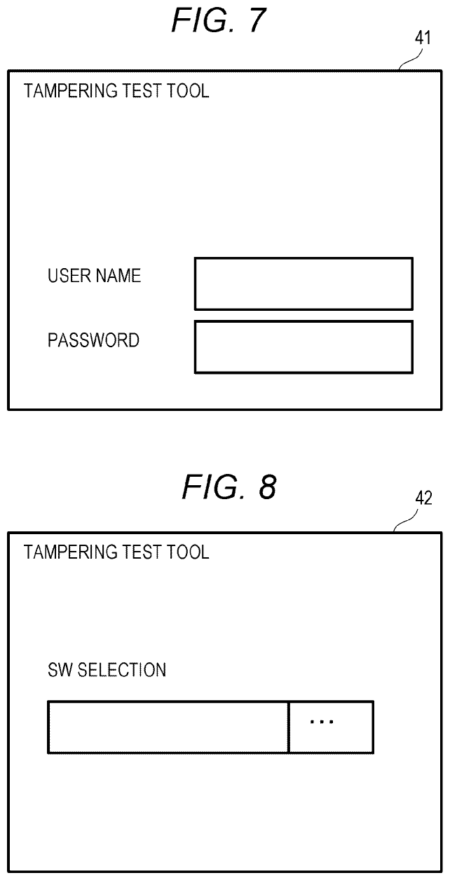

FIG. 7 illustrates an example of an authentication screen 41 for the administrator, for the purpose of tampering of the verification software. The input/output unit 12 in the tampering test tool 10 displays the authentication screen illustrated in FIG. 7 on the output device 304, which causes the administrator to input a user name and a password using the input device 305. The authentication unit 13 transmits an authentication request to the storage system 100, together with the inputted user name and password. In the storage system 100, normal software is operated and, for example, the OS and management software 230 can perform user authentication.

This can permit only a trusted user registered in the storage system to use the tampering test tool. Incidentally, the management device 102 may store reference information for user authentication. The authentication unit 13 can execute user authentication with reference to authentication information which associates a user name with a password, wherein the authentication information is stored in the auxiliary storage device 303.

On receiving a successful result of the user authentication from the storage system 100, the authentication unit 13 notifies the tampering unit 11 of the successful result. The tampering unit 11 display a screen for selecting verification software to be tampered with, by using the input/output unit 12. FIG. 8 illustrates an example of a verification-software selection screen 42. In the verification-software selection screen 42, the administrator can select one piece of verification software for performing the tampering test, out of a plurality of pieces of verification software. For example, a plurality of pieces of verification software 21 having different versions is stored in the auxiliary storage device 303 in the management device 102. The verification software 21 may be downloadable from a server in the management system through a network.

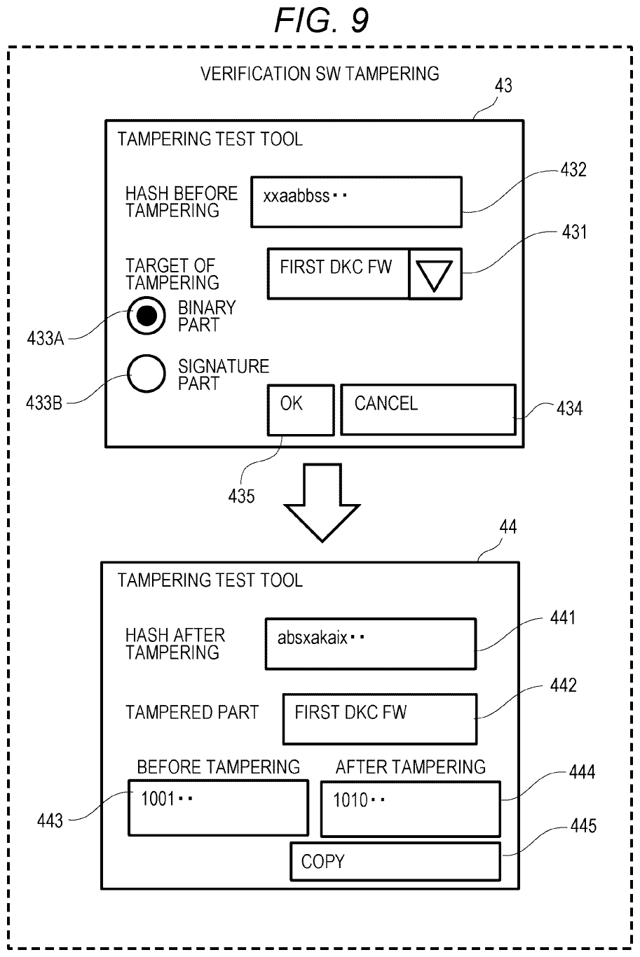

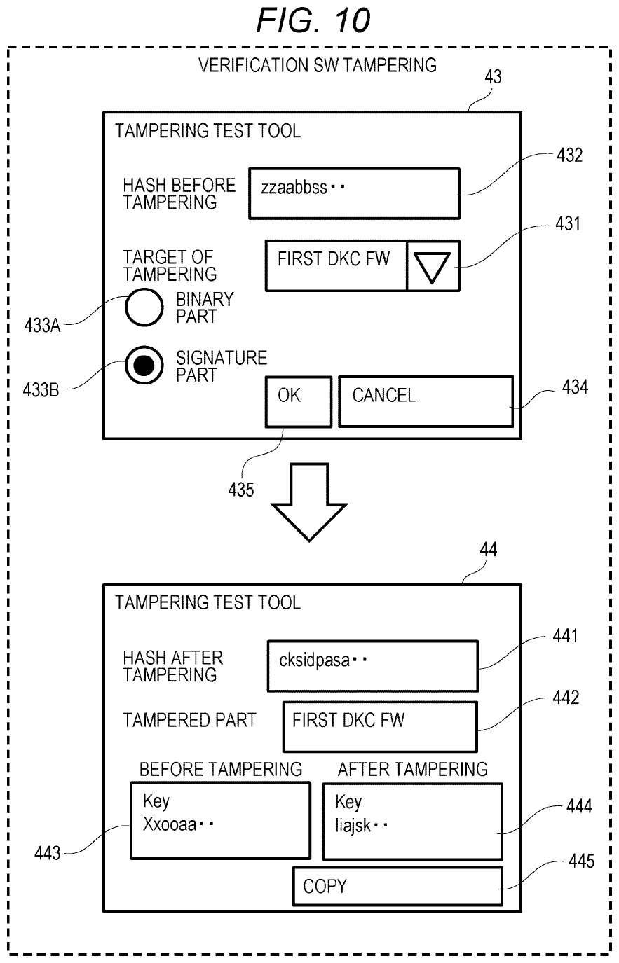

When verification software to be tampered with has been selected, the tampering unit 11 displays a screen for receiving details of the tampering of the verification software 21, using the input/output unit 12. FIGS. 9 and 10 illustrate examples of a tampering input screen 43 and a tampering result screen 44 for the verification software, respectively.

The tampering input screen 43 displays a pull-down menu of parts to be selected, in a section 431. The pull-down menu displays, for example, second MGC firmware, MGC OS, MGC management software, first DKC firmware, and second DKC firmware. The parts displayed by the pull-down menu correspond to the constituent elements illustrated in FIGS. 2 and 3. The second MGC firmware refers to the second MGC firmware 220, and the MGC OS and the MGC management software are each included in the OS and management software 230. The MGC OS and the MGC management software may be also enabled to be collectively selected as the OS and management software. The first DKC firmware refers to the first DKC firmware 250. The second DKC firmware refers to the second DKC firmware 260.

By enabling the user to select a program to be tampered with, it is possible to perform the test of the verification function with higher accuracy. Furthermore, by using the pull-down menu, it is possible to limit the information about the internal structure of the software which is given to the user.

The tampering input screen 43 displays a hash value corresponding to the selected part, in a section 432. The selected part includes a binary part (program part) and a signature part. This enables a test with higher accuracy. The aforementioned hash value is a hash value of the binary part. Further, the signature part is formed from the hash value of the binary part, and a private key.

Two radio buttons 433A and 433B receive selection of a part to be tampered with, out of the binary part and the signature part in the selected part. The signature part is formed from the hash value of the corresponding binary part. In the example illustrated in FIG. 9, the binary part of the first DKC firmware 250 is selected as the part to be tampered with. In the example illustrated in FIG. 10, the signature part of the first DKC firmware 250 is selected as the part to be tampered with. Incidentally, in the present example, one hash value and one signature are created from the OS and management software 230.

If a cancel button 434 is selected, the inputted information is canceled. If an OK button 435 is selected, the tampering unit 11 tampers with the designated part in the verification software 21 according to the inputted information. Furthermore, the tampering unit 11 displays the tampering result screen 44 using the input/output unit 12.

The tampering result screen 44 displays a hash value and the actual binary of the verification software having been tampered with. In the examples illustrated in FIGS. 9 and 10, the tampering result screen 44 presents the tampered part in the verification software 21 in a section 442, and presents the hash value after tampering in a section 441. The value of the part before tampering is presented in a section 443, and the value of the part after tampering is presented in a section 444.

The tampering result screen 44 displays a copy button 445 for copying the tampered verification software 21 to the storage system 100. The user can copy the tampered verification software 21 to the storage system 100 by selecting the copy button 445 in the tampering result screen 44.

If the copy button 445 is selected, the tampering unit 11 transmits, to the storage system 100, the verification software 21 having been tampered with at the designated part. The tampered verification software 21 is stored in predetermined memory areas in the management controller 120A or 120B and in the disk controller 130A or 130B. Hereinafter, it is assumed that the verification software 21 is stored in the storage controller 110A.

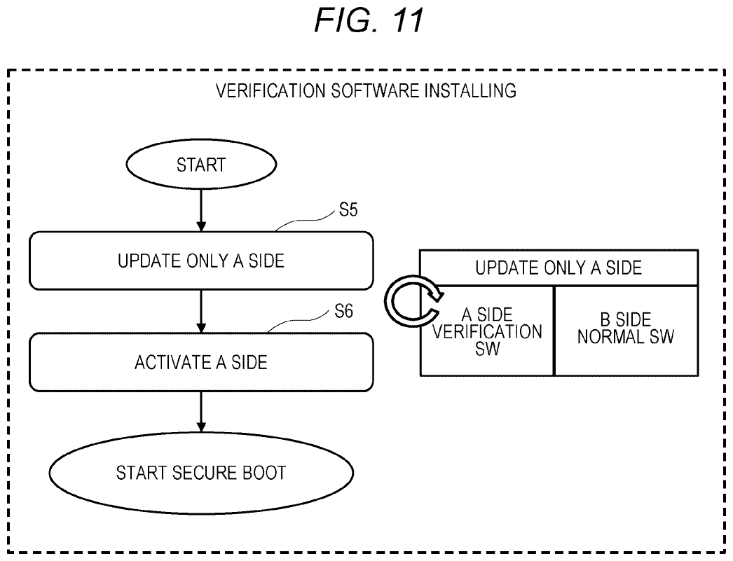

FIG. 11 is a view illustrating a method for installing (copying or storing) the tampered verification software 21 in the storage controller 110A. In the present example, the storage controller 110A stores two pieces of software and executes one of them. The piece of the software to be executed is referred to as A-side software, while the other piece is referred to as B-side software. In normal software updating, the B-side software is updated and, thereafter, the designations of the B-side software and the A-side software are exchanged. Consequently, the updated software becomes the A-side software and is executed by the storage controller 110A.

For example, before the tampered verification software is copied (installed) to the storage controller 110A, the A-side software and the B-side software are normal software to be executed by the storage controller 110A.

On receiving the verification software from the management device 102, the management controller 120A updates the A-side software with the verification software (S5). In updating the A-side software, the A-side software may be directly updated, or the B-side software may be updated with the verification software and, then, the designations of the A-side software and the B-side software may be exchanged. In any of the methods, the A-side software to be executed becomes the verification software 21, while the B-side software is maintained at normal software.

Thereafter, the management controller 120A activates the verification software 21 on the A side (S6). This starts the secure boot of the verification software 21. The management controller 120A executes an update program different from the A-side software and the B-side software to update the A-side software or the B-side software.

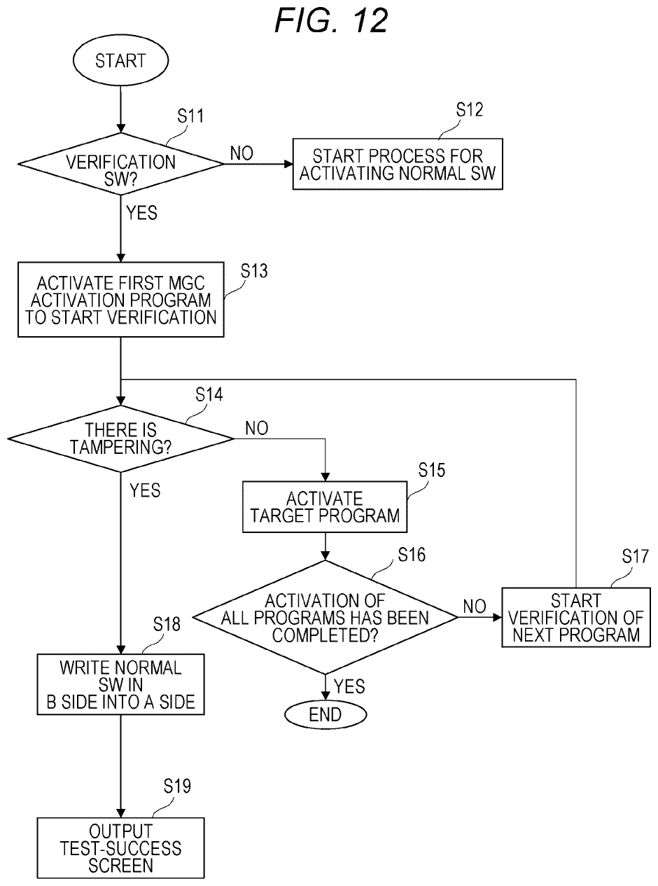

Next, an activation process by the storage controller 110A will be described. FIG. 12 illustrates a flowchart of the activation process by the storage controller 110A. As described above, the A-side software in the storage controller 110A is the tampered verification software 21, while the B-side software is normal software.

First, activation of the management controller 120A is started. The CPU 121A in the management controller 120A executes the A-side software and determines whether the A-side software is verification software or normal software (S11).

For example, a boot loader (not illustrated) refers to a verification-software determination bit in the A-side software. For example, if the verification-software determination bit is 1, the software is verification software, and if the verification-software determination bit is 0, the software is normal software.

If the activated software is normal software (S11: NO), a process for activating normal software is started (S12). If the activated software is the verification software 21 (S11: YES), a process for activating the verification software 21 is started (S13).

Specifically, the first MGC activation program 211 in the first MGC firmware 210 is activated. The first MGC activation program 211 activates the first MGC verification program 212 in the first MGC firmware 210 to execute verification of the second MGC firmware 220, thereby determining whether or not there is tampering therein (S14). If no tampering is detected (S14: NO), the next target program is activated (S15). In this case, the second MGC firmware 220 is activated. If the activation of all the programs has been completed (S16: YES), this flow ends.

If there remains a program not having been activated (S16: NO), verification of the next program is started (S17). In this case, the second MGC verification program 222 executes verification of the OS and management software 230. The flow returns to the step S14.

As described with reference to FIG. 4, the software in the storage controller 110A repeats verification and activation of programs in stages. Specifically, if there is no tampering in the OS and management software 230 (S14: NO), the second MGC startup program 221 activates the OS and management software 230.

The first DKC verification program 231 in the OS and management software 230 is executed to execute verification of the first DKC firmware 250. If there is no tampering in the first DKC firmware 250, the DKC activation instruction program 232 activates the first DKC firmware 250.

The second DKC verification program 252 in the first DKC firmware 250 is executed to execute verification of the second DKC firmware 260. If there is no tampering in the second DKC firmware 260, the DKC initial-phase activation program 251 activates the second DKC firmware 260.

Any part of the verification software has been tampered with. Therefore, in a case where the secure boot of the verification software normally functions, tampering is detected at any part of the verifications and activations in stages.

If any tampering is detected (S14: YES), the program having detected the tempering stops the subsequent activating process. The management controller 120A rewrites the verification software 21 in the A side with the normal software in the B side through a software-side management program (not illustrated) (S18). The normal software having become the A side updates the verification software having become the B side through the software update program after the activation of the program. As a result, both the A-side software and the B-side software become normal software.

The program having detected the tempering stores the result of the verification in log management information in the management controller 120 and transmits a message indicating the result of the verification to the management device 102. The input/output unit 12 in the management device 102 displays the message on the output device 304 (S19). The message indicates that the test of the secure boot function has been succeeded.

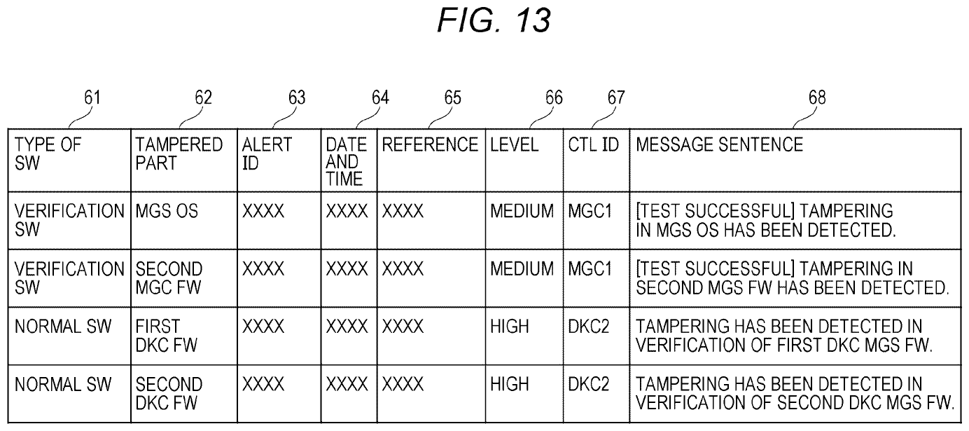

FIG. 13 illustrates an example of a tampering detection message. The tampering detection message can include a plurality of items. In the example illustrated in FIG. 13, the tampering detection message includes items of a type of software 61, a tampered part 62, an alert ID 63, a date and time 64, a reference 65, a level 66, a controller (CTL) ID 67, and a message sentence 68.

The type of software 61 indicates whether the software detected as having been tampered is verification software or normal software. The tampered part 62 indicates the tampered part in the software. The alert ID 63 is an ID of the message, and the date and time is the date and time of the detection of the tampering. The reference 65 indicates an information resource to be referred to regarding the detected tampering.

The level 66 indicates the degree of insecurity of tampering, and the controller ID 67 indicates an ID of the controller (the management controller or the disk controller) storing the software detected as having been tampered with. The message sentence 68 indicates a message sentence to be presented to the administrator. The information of the reference 65, the level 66, and the message sentence 68 are set in advance for the tampered portion. The tampering detection message enables the administrator to acquire information about the tampering.

In one embodiment of the present specification, the tampering test tool 10 presents the status of progress of the verification of the verification software, to the administrator. This can visualize the status of the verification of the verification software, thereby improving the convenience for the administrator.

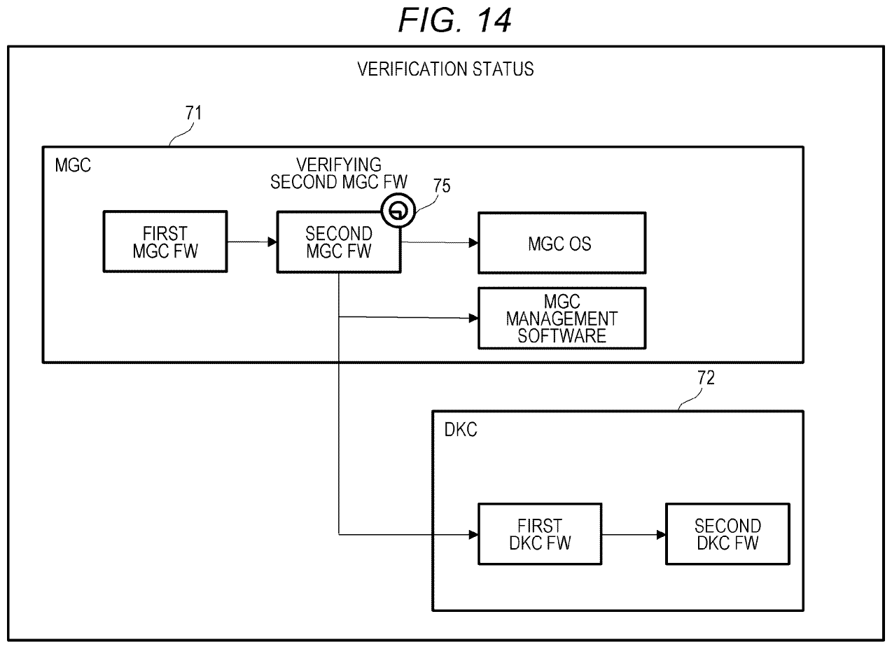

FIG. 14 illustrates an example of a verification-status screen. The verification-status screen clearly presents the program structure of the verification software, and the program (part) being currently verified. Each rectangle indicates a program, and arrows indicate the order of activation of the programs. A rectangle 71 indicates the programs in the management controller 120A, and a rectangle 72 indicates the programs in the disk controller 130A. In the example illustrated in FIG. 14, tampering in the second MGC firmware is being verified, which is indicated by a circle 75.

If each program in the verification software is activated, this program transmits the information thereabout to the management device 102. The input/output unit 12 updates the verification-status screen, in response to the notification of activation of each program, which has been received from the storage controller 110A.

The present invention is not limited to the aforementioned embodiment, and covers various modifications. For example, the aforementioned embodiment has been described in detail, for the purpose of illustrating the present invention in such a way as to facilitate understanding the present invention, and the present invention is not necessarily limited to structures including all the described structures. Further, a structure according to a certain embodiment can be partially replaced with a structure according to another embodiment and, also, a structure according to a certain embodiment can be additionally provided with a structure according to another embodiment. Further, a structure according to each embodiment may be partially eliminated, provided with other additional or replaced structures with other structures.

Further, some or all of the aforementioned structures, functions, processing units, and the like may be realized through hardware, for example, by designing with an integrated circuit. Further, each of the aforementioned structures, functions, and the like may be realized through software by a processor interpreting and executing programs for realizing the respective functions. Information such as programs, tables and files for realizing the respective functions can be stored in a recording device such as a memory, a hard disk, or a solid state drive (SSD), or in a recording medium such as an IC card, an SD card, or a DVD.

Further, there have been illustrated control lines and information lines considered to be necessary for description, and not all the control lines and the information lines in the product are illustrated. It may be considered that almost all the structures are connected to each other, in actual.

1. A system for performing test for tampering verification in activation of software to be executed by a storage controller, the system comprising:
a management system; and
a storage controller,
wherein the management system stores verification software to be executed by the storage controller,
the verification software includes a program for detecting tampering in the verification software,
the management system is adapted to tamper with a part of the verification software according to an instruction from a user, and to install the verification software tampered with at the part in the storage controller,
the storage controller is adapted to activate the verification software, and
the management system is adapted to present, to the user, a result of verification of tampering by the verification software, which is received from the storage controller.

2. The system according to claim 1, wherein
the verification software includes a plurality of programs, and
in the plurality of programs, a preceding program verifies a subsequent program, and in a case where there is no tampering, the subsequent program is activated, and
the management system receives, from the user, designation of a program to be tampered with in the verification software.

3. The system according to claim 2, wherein
the management system receives selection of a digital signature part or a binary part, in the program to be tampered with.

4. The system according to claim 1, wherein
in the verification software, some of functions of normal software to be executed by the storage controller are omitted.

5. The system according to claim 1, wherein
the storage controller stores A-side software and B-side software,
the storage controller is adapted to activate the A-side software,
the verification software is installed as the A-side software, and
the B-side software is normal software.

6. The system according to claim 5, wherein
the storage controller updates the verification software subjected to the detection of tampering, with the normal software as the B-side software.

7. The system according to claim 2, wherein
the management system is adapted to receive information about a current verification status of the verification software from the storage controller, and
to present information about the current verification status to the user.

8. A method for performing test for tampering verification in activation of software to be executed by a storage controller, the method comprising:
causing a system to acquire verification software to be executed by the storage controller, the verification software including a program for detecting tampering in the verification software;
causing the system to tamper with a part of the verification software according to an instruction from a user;
causing the system to install the verification software tampered with at the part in the storage controller and to activate the verification software; and
causing the system to present, to the user, a result of verification of tampering by the verification software, which is received from the storage controller.
